(19) United States
(12) Patent Application Publication
(10) Pub. No.: US 2008/0267017 A1
(43) Pub. Date: Oct. 30, 2008

(54) NOVEL WATCHCASE ASSEMBLY

(76) Inventor: Michelle J. Fuwausa, Columbia, MD (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/108,128

(22) Filed: Apr. 23, 2008

Related U.S. Application Data
(60) Provisional application No. 60/913,893, filed on Apr. 25, 2007.

(51) Int. Cl. G04B 37/00

(52) U.S. Cl. 368/286

(57) ABSTRACT

A watchcase is provided including a watchcase and an exoskeleton. The exoskeleton is aesthetically pleasing and engineeringly sound, encompassing the watchcase and protecting it from everyday wear and tear, of which it could be totally independent from the watchcase or could be attached to the watchcase in a supportive manner with connectors attaching it to the watchcase and connected with screws and separate supportive parts, reinforced from the exoskeleton mainframe to the top of the watchcase. The supports or connections could be engineered to evenly distribute any stress points, creating a ridged protective barrier for the watchcase.

### RELATED APPLICATIONS

This application claims priority to provisional application Ser. No. 60/913,893 filed Apr. 25, 2007, entitled “Exoskeleton Supporting A Watchcase”, and incorporated herein by reference.

### BACKGROUND OF THE INVENTION

1. Field of Invention

This invention pertains to wristwatches, and more particularly to watch case assembly formed of an external protective ring, a plurality of connectors and a watch case.

2. Description of the Prior Art

Wristwatches, and specifically watchcases, are manufactured to protect the watch movement and conversely produced in shapes and designs that are aesthetically pleasing and saleable to the consumer marketplace. Watchcases are produced from various metals that have different strengths and durability for different environmental conditions. Several metals and alloys are well know in the industry that are particularly suitable for wristwatch cases because they are suited for this purpose including stainless-steel, such as, 904L or 316L, as well as various platinum and gold alloys. Any wristwatch actively worn is subject to wear and tear over the year. This invention relates generally to a protective barrier, or exoskeleton, on the outer perimeter of a wristwatch case.

Historically, watchcases are designed to serve as protection for the inside of the watches caliber or movement complications as described in U.S. Pat. No. 4,068,464, Barnett. During World War 1, early military wristwatches used protective grilles over the dials while other models have faces that are changed by sliding the case dial, reversing to a metal cover. Other means of protection include the use of flexible substrate that has an extended flap, as described in U.S. Pat. No. 6,199,730 B1, Chisolm, and U.S. Pat. No. 6,799,887 B1, Kinney. Other means include an entire encompassing of the watchcase with a hardened substrate, as described in U.S. Pat. No. 3,643,423, Piquerez, or a shutter device described in U.S. Pat. No. 5,805,535 Guyard et al, and U.S. Pat. No. 6,739,748 B2, Della Santa or even a watchcase inside of a watchcase as described in U.S. 2006/0034161 A1, Muller or U.S. 2008/0074958 A1, Moran. In these references, protection either restricts the aesthetic appeal of the wristwatch or exaggerates its protection verses it wear ability.

The following concepts comprise various aesthetic and function ability and therefore improvements to the basic patents or patent pending, of these inventions.

### SUMMARY OF THE INVENTION

A feature of the present invention that is an improvement over the prior art provides watch case assembly constructed and arranged to protect watchcase from abrasions and impact.

It is further feature of the present invention is that it provides a watch case assembly including an exoskeleton that could be circular to match the outer perimeter of a standard watchcase or could have other creative shape to accommodate and match the shape of a wristwatch.

Another feature is that provides exoskeleton protection that allows the wristwatch case to be made from softer materials such as gold or plastics and which can be power coated, or painted in fashionable colors. The watchcase assembly can be painted and clear coated like an automobile but can protect the watch from direct impact therefore reducing chips and scratches.

More specifically, the present invention provides a watch case assembly including or incorporating a protective exoskeleton attached to a watch case. In a preferred embodiments includes “0” ring shaped body and several connectors used to connect and mount the ring to the case. The connectors are coupled to the ring and the case by traditional coupling means, such as screws, and the like. These connectors are preferably designed and constructed to distribute stress and impact evenly throughout the structure.

More specifically, the present application pertains to an exoskeleton which could be in the shape of a metallic ring, an “O” ring, that is aesthetically pleasing and sound from engineering view. The case encompasses the outer perimeter of a watchcase, protecting it from everyday wear and tear, and independent from the watchcase or could be attached to the watchcase in a supportive manner with cantilevers stretching from the surface and leading underneath the watchcase, connected with screws and separate supportive parts. The supports or connections could be engineered to evenly distribute any stress points, creating a ridged protective barrier for the watchcase.

### BRIEF DESCRIPTION OF THE DRAWINGS

The invention will be better understood by reference to the following description, taken in connection with the appended drawings, in which the reference numerals indicate the parts, and in which,

FIG. 1 shows a front view of a watchcase assembly constructed in accordance with this invention;

FIG. 2 shows a back view of the watchcase assembly;

FIG. 3 shows a first orthogonal view of the watchcase assembly;

FIG. 4 shows a second orthogonal view of the watchcase assembly;

FIG. 5 shows an exploded view of the subject watchcase assembly; and

FIG. 6 shows a complete watch with a movement, a crystal, and the subject watchcase assembly.

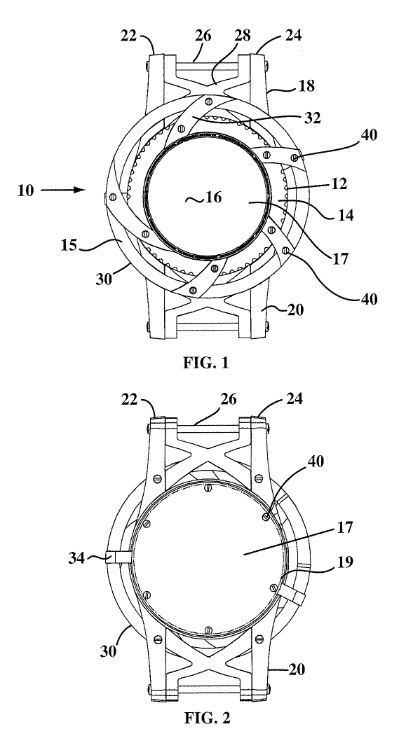

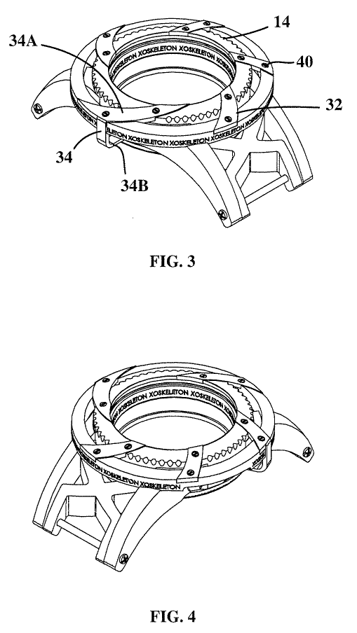

### DETAILED DESCRIPTION OF THE INVENTION

As shown in the Figures, a watchcase assembly 10 having a watchcase 12 with a body 14 having a top surface 16 defined around a cavity 16 with a bottom wall 17. The cavity is sized and shaped to receive a standard watch movement. Once the movement is placed in the cavity 16, a crystal is placed on the top of the movement and affixed to the watchcase to protect close the cavity and protect the movement.

The watchcase 12 further includes two lugs 18, 20 extending away there from. Each lug includes two generally parallel arms 22, 24 and a pin 26. As discussed later, the lugs are used to affix a band to the case in a standard manner. The lugs may further include additional arms 28 that provide further strength to the lugs, or merely to provide some additional aesthetic elements.

The assembly further includes a protective exoskeleton formed of an outer ring 30 and a plurality of connectors 32 mounting the ring 34 to the watchcase 12. Two kinds of connectors are provided: a short connector 32 that extends between and is attached to the top surface 14 of case 12 and the top surface 15 ring 30 and a long connector 34 that has one end attached to the top surface 14 of the case and the top surface 15 of the ring, but then continues downward around the ring 30 and extends radially back to the case 12 where it is attached to the bottom surface 19 of bottom wall 17. In one embodiment, the long connector 34 could be formed of two sections: a top section 34A having the size and shape of short connector 32, and a bottom section 34B that is generally L-shaped as shown. The two sections are joined by soldering or other similar methods. Preferably the connector is made from a single piece.

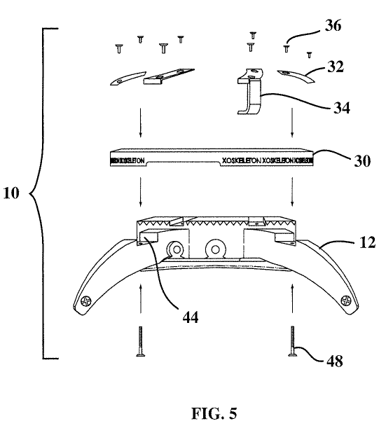

The connectors 32, 34 can be attached to the case and/or ring by any well known means. In the Figures, the connectors are attached to the case by appropriately sized screws 40. Since the lugs 18, 20 extend radially past the ring 30, they are also attached to the ring by screws or other means to provide added extra strength and rigidity to the exoskeleton. Moreover, notches as at 44 may be provided in the lugs to receive ring 30. Preferably, screws 48 are inserted from the bottom surface of the lugs and extend through the lugs and into respective threaded holes in the ring 30 thereby securing the ring 30 to the lugs, as shown in FIG. 5.

In the embodiment shown, the ring 30 has the same shape as the watchcase 12 and follows its perimeter fairly closely so that there is an even annular space formed between the ring and the watchcase. Of course, the two parts need not have the same shape. Either, or both can have round, oval, rectangular, octagonal or even random shapes, etc.

The advantages of the exoskeleton are obvious to one skilled in the art. The exoskeleton provides a bumper zone that protects the watchcase 12. As a result, the watchcase can be made of softer material, such as gold layering, gold IP, rubber or painted with a clear coating, since it will be protected from scratches or dents by the exoskeleton. The exoskeleton is preferably made of a much harder, more durable material, such as a 904L or 316L stainless-steel.

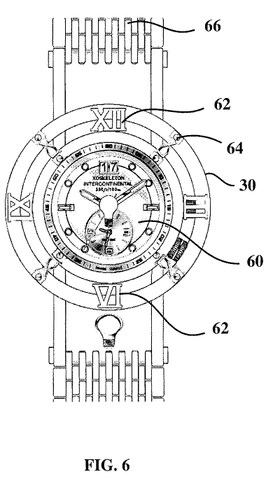

FIG. 6 shows a slightly different embodiment of a watchcase assembly complete with movement. In this embodiment, the movement 60 is provided in the cavity formed in the watched case and a standard crystal (not shown) is installed on top to protect the movement. In this embodiment, connectors 62 (having the shape of Roman numerals) and straight connectors 64 are used to join the watch case to ring 30. Moreover a watchband 66 is also added to complete the watch.

Obviously numerous modifications may be made to the invention without departing from its scope as defined in the appended claims.

I claim:

1. A watchcase assembly comprising:
a watchcase having a body with an external perimeter and an internal cavity, said cavity being sized and shaped to receive a watch movement; and
an exoskeleton sized and shaped around said periphery to protect said watchcase, said exoskeleton including a ring and connectors extending between and attached to said ring and said watch case,

2. The watchcase assembly of claim 1 wherein said ring and said watch have respective top surfaces and wherein said connectors are attached to said top surfaces.

3. The watchcase assembly of claim 1 wherein said case has a bottom surface and at least one of said connectors is attached to said bottom surface and said ring.

4. The watchcase assembly of claim 1 wherein said one connector is U-shaped and includes a first portion attached to one surface of the case and the ring and a second side connected to said bottom surface.

5. The watchcase assembly of claim 1 wherein said connectors are attached by screws.

6. The watchcase assembly of claim 1 wherein said watchcase includes lugs for receiving a watchband, and at least one screw securing said ring to one of said lugs.

7. The watchcase of claim 6 wherein said one of said lugs has a lug bottom surface and said one screw extends from said lug surface through said lug and engages said ring.

8. A watch comprising:
a watchcase with a body forming a cavity with a bottom wall;
a movement disposed in said cavity;
a crystal disposed over said cavity; and
an exoskeleton having a ring disposed peripherally about said case and a plurality of connectors attaching said ring to said case.

9. The watch of claim 8 wherein said ring and case have respective top and bottom surfaces and said connectors are attached to one of said top and bottom surfaces,

10. The watch of claim 9 wherein said connectors include a short connector attached only to one surface of said body and a long connector attached to both surfaces of said case.

11. The watch of claim 10 wherein said connector is attached to said ring.
